(19) United States
(12) Patent Application Publication
(10) Pub. No.: US 2008/0120706 A1
(43) Pub. Date: May 22, 2008

(54) Network audio / video communication system and method

(75) Inventors: Soon-Kheng Thang, Penang (MY); Jui-Feng Chai, Taipei City (TW); Ting-Chang Kuo, Taipei City (TW)

Correspondence Address: RABIN & Berdo, PC, 1101 14TH STREET, NW, SUITE 500, WASHINGTON, DC, 20005, US

(73) Assignee: INVENTEC MULTIMEDIA & TELECOM CORPORATION, Taipei City (TW)

(21) Appl. No.: 11/601,711

(22) Filed: Nov. 20, 2006

(51) Int. Cl. H04L 9/32

(52) U.S. Cl. 726/5

(57) ABSTRACT

A network audio/video communication system and a method thereof, which is used to ensure data security of a audio/video communication conducted through a network by verifying the user ID codes of a sending party and a receiving party and locking-in of the communication between the two parties. The method is realized through the following steps: activating the audio/video communication session; verifying the user ID codes of the sending party and the receiving party; determining the authorization level of the receiving party by the sending party, based on the user ID code of the receiving party; locking-in the communication connection between the sending party and the receiving party, and activating the communication connection between the sending party and the receiving party.

### BACKGROUND OF THE INVENTION

1. Field of Invention

The invention relates to a network audio/video communication system and a method thereof, and more particularly, to a network audio/video communication system with a data security guarantee and a method thereof. The data security of the audio/video communication conducted through the network is ensured through verifying the user ID codes of a sending party and a receiving party and locking-in the communication between the two parties.

2. Related Art

Nowadays, the application of the network is getting ever more popular, so that the users at remote ends can be connected to each other through network communication. It may further be utilized to carry on audio/video communication sessions, so that numerous individuals may communicate between/among each other. Usually, in network communication, various important data is involved, thus the security of the system and network must be taken into special consideration to prevent the abuse of such important data and the exposure of such important data in the network. In this respect, a system and method utilized in controlling the introduction of new nodes is disclosed in U.S. Pat. No. 6,851,053, which is used to safeguard the security mechanism of the transport layer and the authorization exchange of the application layer during a communication session. In this invention of the prior art, a new communication node is not allowed to be connected directly to the top provider of the communication session. Instead, a participation request and its authorization identification are first sent to the top provider of the communication session by the new communication node. Then the first node of the session receiving the request performs the authorization of the transport layer of the new node, the authorization of the new node and its application for the application layer are transmitted to the top provider, which is used to verify the identity of the new node based on the authorization. If it is verified and determined that the new node is allowed to join in this communication session, then the top provider updates the participation list of the communication session, so that the authorization of this new node is applicable to other nodes of this communication session, as such other nodes of the communication session are able to verify the authority of the new node. However, in this invention of prior art, only one communication session is allowed to be established, and it is controlled and managed through the password and the security features of the ordinary user. Yet, the security of the ordinary user is liable to change due to various reasons, thus various users may have the problems relating to data security, such as lost data or other related problems in network communication.

In this respect, in case the security system is not capable of providing sufficient protection to the entire communication system, some of the important data may be vandalized by an unauthorized user. As such, in case only the user ID code is verified instead of the Media Access Control (MAC) address while connecting to the network session, then the unauthorized user may get easily into the communication session.

In the afore-mentioned network session, all the participating parties have the same level of authorization of reading and writing data, hereby some important data is liable to be exposed, and the top provider responsible for managing the session is not capable of changing the authorizations of the parties participating in the session.

Even if some of the systems are designed to provide the users with the capability of selecting the level of authorization, however, in the proceeding of the communication session, the authorization of the users can not be changed. Therefore, if the authorization of the users has to be changed, then the users must first withdraw from the session, and then re-enter into the communication session again.

### SUMMARY OF THE INVENTION

In view of the above-mentioned drawbacks and shortcomings of the prior art, the objective of the invention is to provide a network audio/video communication system with a data security guarantee and a method thereof, in which the data security of the network audio/video communication is safeguarded and protected through verifying the user ID codes of a sending party and a receiving party of the communication signals and locking-in the communication between the two parties.

Therefore, to achieve the above-mentioned objective, the invention provides a network audio/video communication system with a data security guarantee, which includes a user ID code verification module, a comparison module, an authorization module, a lock-in module and a network communication module. The user ID code verification module is used to verify the user ID code for ensuring that only the registered user may enter into the session. The comparison module is used to compare the user ID code with the pre-stored registered user ID code. The authorization module is used to enable the sending party to define the authorization of the receiving party. The lock-in module is used to lock-in the connection between the sending party and the receiving party. The network communication module is used to activate or close the network connection, so that the sending party and the receiving party may share the data of both parties.

In addition, to achieve the above-mentioned objective, the invention provides a network audio/video communication method with a data security guarantee, wherein the data security of the audio/video communication conducted through the network is ensured through verifying the user ID codes of a sending party and a receiving party and locking-in the communication between the two parties. The method comprises the following steps: activating an audio/video communication session; verifying the user ID codes of the sending party and the receiving party; determining the authorization level of the receiving party based on verifying the user ID code of the receiving party by the sending party; locking-in the current communication connection between the sending party and the receiving party, and activating the current communication connection between the sending party and the receiving party.

According to the present invention, the authorization of the communication between the sending party and the receiving party can be achieved by verifying the user identification (ID) codes of the sending party and the receiving party, hereby ensuring that only the verified user may enter the communication session and raising the security level of the system. Furthermore, the present invention is used to verify the ID code of the user before connecting the user to the session, hereby preventing the unauthorized user from being connected to the session, which is particularly important when private or confidential information is involved in the session. In the present invention, the sending party, as the top provider responsible for managing the session, is capable of deciding the authorization level of the receiving party of the session. Furthermore, different receiving parties are assigned to different authorization levels. Therefore, in the communication session, the sending party may decide if the receiving party may have full authorization, as allowed to communicate with all the parties in this session, or partial authorization, as allowed to communicate with the sending party rather then the other parties. In the present invention, the Media Access Control (MAC) addresses of all the participating parties, including that of the sending party and the receiving party, can be obtained for ensuring a higher level of security. The obtained MAC addresses may also be locked-in by the present invention. In general, different parties are provided with different MAC addresses, so the security of the communication session is double checked. During the current communication connection, the sending party is allowed to change the authorization level of the receiving party, even if the receiving party with changed authorization level is reconnected to the session, the current communication can be protected. The present invention may not only be applied to the communication equipment, but it may also be further utilized in the communication between the related communication equipment and computer. According to the present invention, the sending party and the receiving party may share the audio and video data through the related communication equipment, such as the computer and network camera. Furthermore, a shared file is created in the computer to store the shared information as required by all the sending parties and the receiving parties.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus is not limitative of the present invention, wherein:

FIG. 1 is a system block diagram of the network audio/video communication system according to an embodiment of the present invention;

FIG. 2 is a flowchart of the steps of a method of network audio/video communication according to an embodiment of the present invention;

FIG. 3 is a flowchart of the steps of the method of activating an audio/video communication session according to an embodiment of the present invention;

FIG. 4 is a flowchart of the steps of a method of verifying the user ID codes of the sending party and the receiving party according to an embodiment of the present invention;

FIG. 5 is a flowchart of the steps for determining the authorization level of the receiving party by the sending party according to an embodiment of the present invention; and

FIG. 6 is a flowchart of the steps for locking-in the communication connection between the sending party and receiving party according to an embodiment of the present invention.

### DETAILED DESCRIPTION OF THE INVENTION

The purpose, construction, features, and functions of the invention can be appreciated and understood more thoroughly through the following detailed description with reference to the attached drawings.

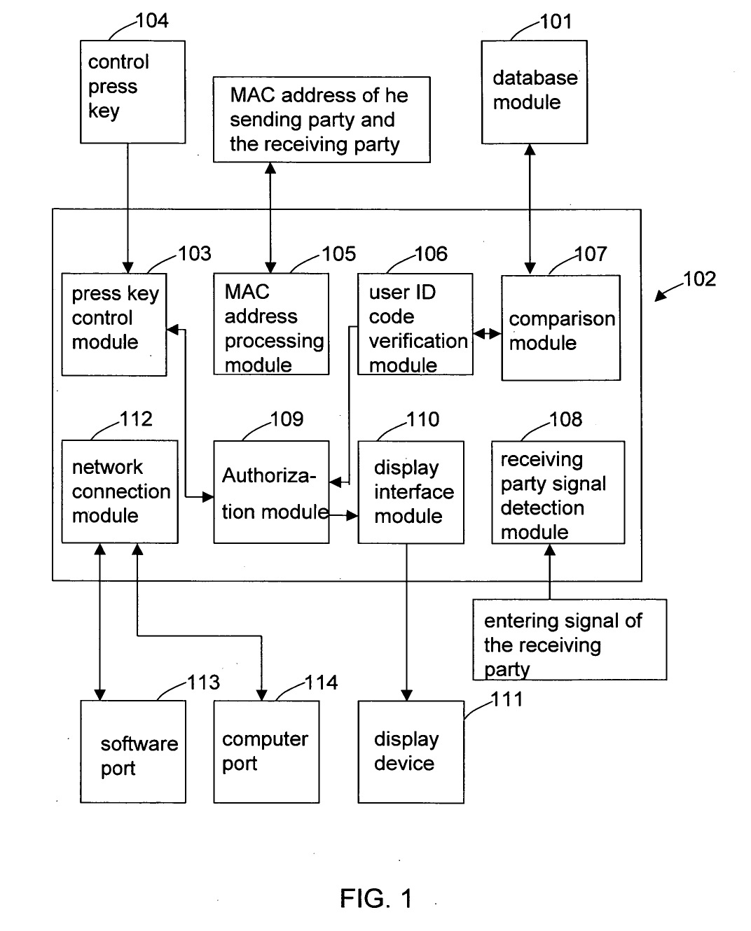

Firstly, refer to FIG. 1 for a system block diagram of the present invention. Upon initiating an audio/video communication session, an entering signal of the receiving party is sent to a processing module 102, which is used to order a user ID code verification module 106 to verify the user ID code for ensuring that only the registered users may enter into the session. When the receiving party is connected to the session, a receiving party signal detection module 108 may detect the entering signal of the receiving party, and then the entering signal is sent to the user ID code verification module 106 to certify the entering user is already properly registered. Subsequently, the user ID of the receiving party is compared with the data in the database module 101 of the sending party by a comparison module 107 for ensure that the receiving party is already properly registered. Upon verifying the validity of the user ID code, a specific code is added to the user ID code by the user ID code verification module 106 for raising the security level of the session. Upon verifying the validity of the user ID code of the sending party and receiving party, the processing module 102 signals an authorization module 109, so that the sending party may define the authorization of the receiving party. In the process of authorization, the selected authorization status displayed on a displaying device 111 is transmitted as a verification signal through pressing a control press key 104 by the sending party and then processed by a press key control module 103. Then, a signal is transmitted from a MAC address-processing module 105 to the processing module 102 for obtaining the MAC address from the communication between the sending party and the receiving party. Moreover, a lock-in signal is generated by the MAC address processing module 105 for locking-in the above-mentioned communication between the sending party and the receiving party. Through the above-mentioned initialization processes, various alert messages are displayed on the display device 111 through a display interface module 110. The communication between the sending party and the receiving party is conducted through the equipment with a computer. In addition, a network connection module 112 with a software port 113 and a computer port 114 is utilized to connect the equipment and the computer, so that the sending party and the receiving party may share data each other.

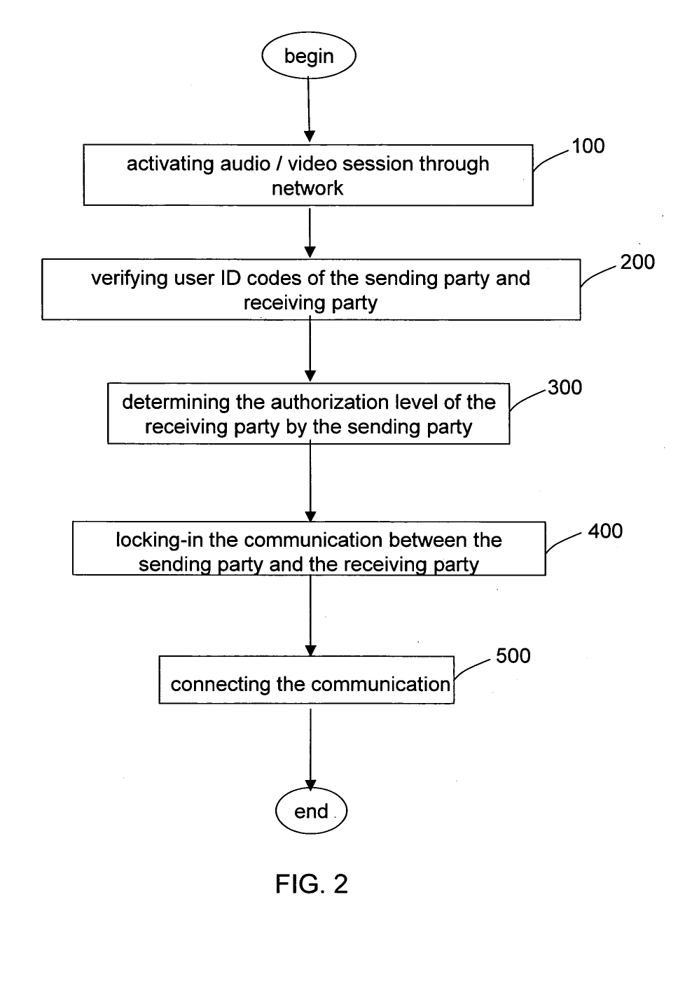

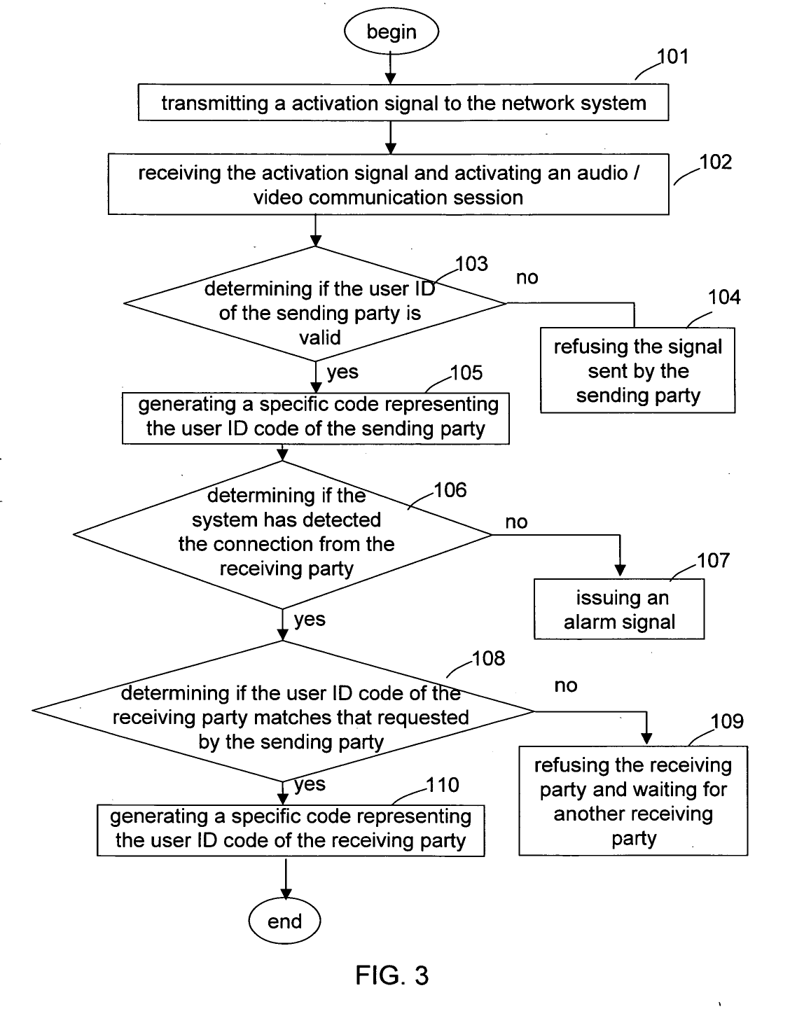

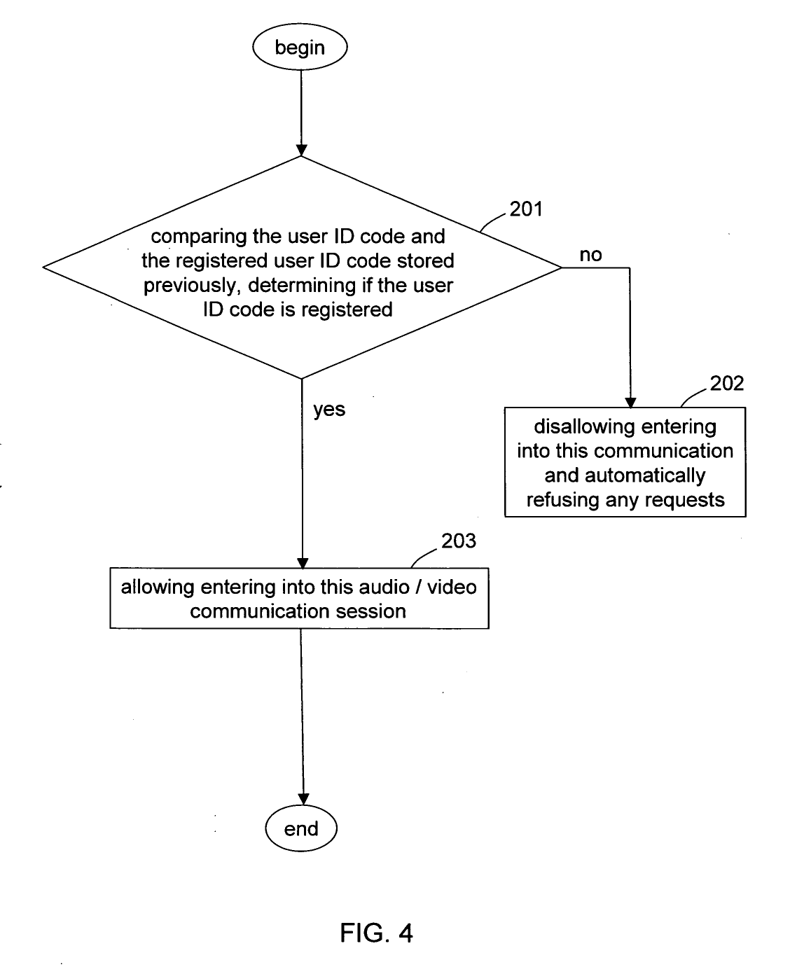

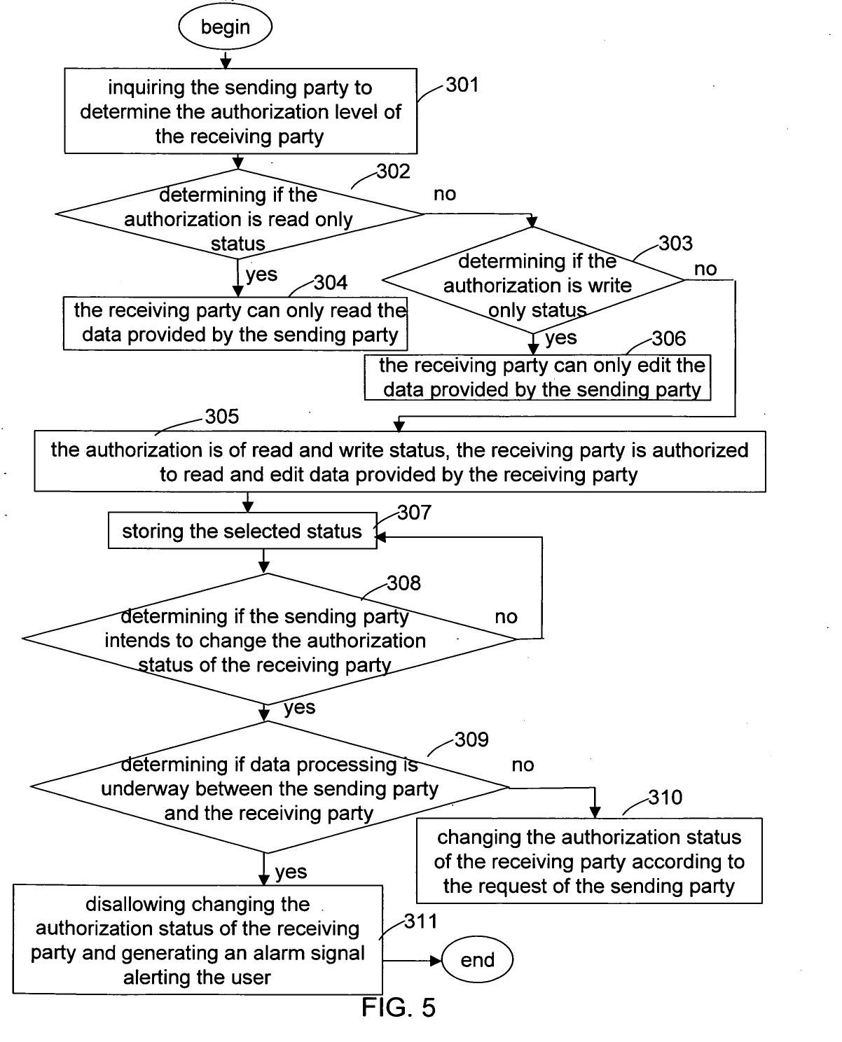

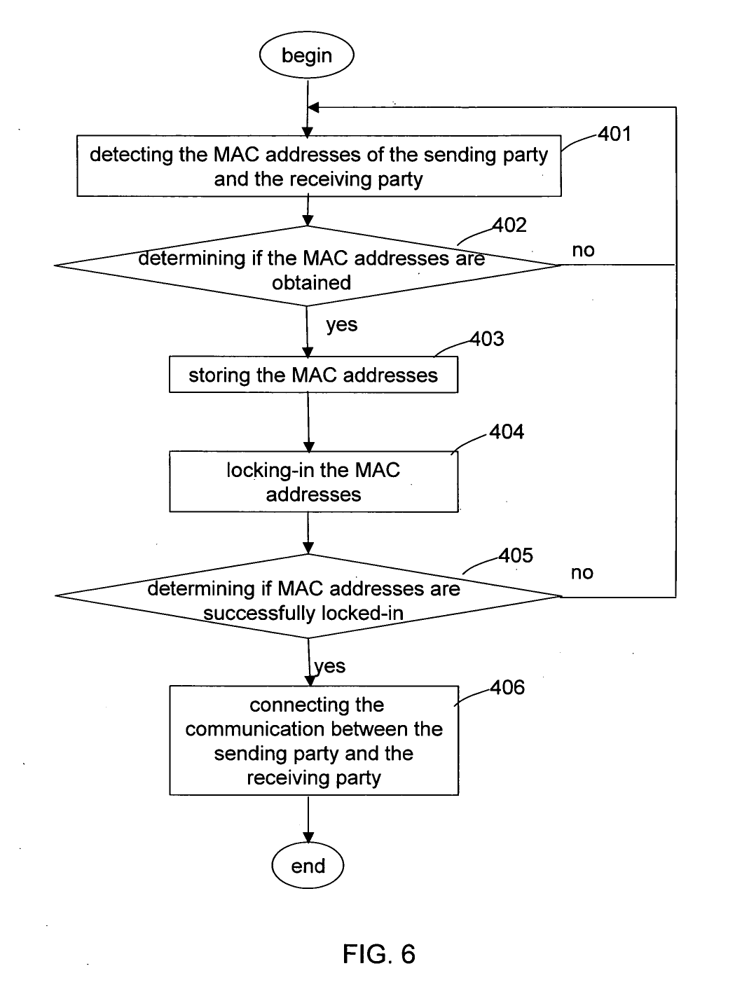

Next, refer to FIG. 2 for a flowchart of the steps of a method of network audio/video communication according to an embodiment of the present invention. Upon activating an audio/video communication session, a signal is transmitted to the network system, requesting activation of this specific function (step 100), the details of this step will be described in FIG. 3. Next, the user ID codes of the sending party and the receiving party are verified by the system of the present invention, thus ensuring that the user is authorized (step 200), the details of this step will be described in FIG. 4. Then, upon verifying if the user ID code is correct, the sending party determines the authorization level of the receiving party and certifies the authorization task to the receiving party (step 300), the details of this step will be described in FIG. 5. Subsequently, once the authorization of the receiving party is determined, the communication between the sending party and the receiving party is locked-in by the system of the present invention, hereby ensuring that an unauthorized user is not allowed to get into the session and data will not be lost (step 400), the details of this step will be described in FIG. 6. Finally, upon activating the lock-in function, the connection of this communication is activated (step 500). In the following, the details of the afore-mentioned steps 100,200, 300, 400, will be described.

Then, refer to FIG. 3 for a flowchart of the steps of the method of activating an audio/video communication session according to an embodiment of the present invention. As shown in FIG. 3, firstly, upon activating an audio/video communication session, an activation signal requested for activating this session is transmitted to the network system (step 101). Next, the network system receives the activation signal and then activates an audio/video communication session (step 102). Then, the communication system determines the verification status of the user ID code of the sending party, hereby ensuring that the sending party is authorized to activate this function (step 103). If it is verified that the user ID of the sending party is invalid, then the signal transmitted by the sending party is denied transmission (step 104); otherwise, a specific code is generated by the network system, indicating the user ID code of the sending party (step 105). The specific code is utilized as a double security code to enhance the security provided by the user ID code, and is not easy to be duplicated by an unauthorized user. Upon fully verifying the validity of the user ID code of the sending party, the communication system of the present invention is then used to wait for connecting with the receiving party, and determine if the system detects the connection from the receiving party (step 106). If it is determined that the connection from the receiving party is not yet established, then an alarm signal is issued to alert the user (step 107). For example, the alarm signal displayed on a liquid crystal display could be “the receiving party has not been detected, please try again later”. Otherwise, if it is determined that the connection from the receiving party is established, the system verifies the verification status of the user ID code of the receiving party (step 108). If it is determined that the user ID code of the receiving party is not matched to that requested by the sending party, the system flatly refuses to accept the receiving party and waits for the next receiving party until it finds a matching receiving party (step 109). Otherwise, if it is determined that the user ID code of the receiving party is matched to that requested by the sending party, then the system automatically issues a specific code as the user ID code of the receiving party (step 110).

Subsequently, refer to FIG. 4 for a flowchart of the steps of a method of verifying the user ID codes of the sending party and the receiving party according to an embodiment of the present invention. The user ID code is compared with the pre-stored user ID code that has been registered, to verify the status of the user ID code (step 201). If it is verified that the user has not been registered, then an alarm signal is issued to remind the user to register, thus the user is not allowed to enter into the communication session, and any requests from the user are automatically refused (step 202). For example, the alarm signal displayed on a liquid crystal display could be “the user has not been registered yet, please register to complete the subsequent steps, and please be excused for any inconvenience”. Otherwise, if it is verified that the user has been registered, then the user is allowed to enter into this audio/video communication session (step 203).

Moreover, refer to FIG. 5 for a flowchart of the steps for verifying the authorization level of the receiving party by the sending party according to the network audio/video communication method of the present invention. Firstly, upon reaching the step of determining the authorization of the receiving party, a question signal generated by the system is transmitted to the sending party to determine the authorization level of the receiving party (step 301). For example, the question signal displayed on the liquid display device could be the following:

please make the authorization selection:

read only

write only

read and write

In total, there are three authorization selections, as read only, write only, read and write, for the user to choose. The read only state is defined as the state that the receiving party can only read the data provided by the sending party. The write only state is defined as the state that the receiving party may only edit some of the data provided by the sending party. The read and write state is defined as the state that the receiving party is given the authorization of reading and editing the data provided by the sending party.

For continuation of the description of the steps described in FIG. 5, determining if the authorization selected by the sending party is the read only state (step 302), if the answer is affirmative, then the receiving party can only read the data provided by the sending party (step 304). If the answer is negative, determining if the authorization selected by the sending party is the write only state (step 303). If the answer is affirmative, then the receiving party can only edit the data provided by the sending party (step 306). If the answer is negative, then it is determined automatically by the system that the authorization selected by the sending party is a read and write state, thus the receiving party is given the authorization of reading and editing the data provided by the sending party (step 305). The next, the system stores the authorization status selected by the sending party (step 307). Subsequently, the system determines if the sending party decides to change the authorization status of the receiving party (step 308). If the answer if affirmative, determining if the data processing need be performed between the sending party and the receiving party (step 309). When the data processing is requested, then refusing the change of authorization status of the receiving party, and generating an alarm signal to alert the user (step 311). For example, the alarm signal displayed on a liquid crystal display is “authorization is not allowed to be changed for the present, data processing is underway, please try again later”. Otherwise, when the data processing is not requested, the system changes the Authorization Status of the receiving party as required by the sending party (step 310).

Finally refer to FIG. 6 for a flowchart of the steps for locking-in the communication connection between the sending party and the receiving party according to an embodiment of the network audio/video communication method of the present invention. As shown in FIG. 6, firstly, a signal is generated and issued by the system for detecting the MAC addresses of the sending party and receiving party (step 401). Next, the system determines if the related MAC addresses are obtained (step 402). If the answer is negative, a signal is automatically generated by the system to activate the detection again. Otherwise, if the answer is positive, then the obtained MAC addresses are stored automatically by the system (step 403). Subsequently, a lock-in signal is generated by the system to lock-in the MAC addresses (step 404). The lock-in signal is used to prevent an unauthorized user from entering into the communication session, thus the entire communication line is constantly monitored by the system to ensure that only the authorized user may enter into the communication session, hereby providing complete protection for the data flow of the communication between the sending party and the receiving party. Furthermore, determining if the lock-in of the MAC addresses is successful (step 405). If the answer is negative, then the MAC addresses obtained from the sending party and receiving party are automatically re-examined by the system. Otherwise, if the answer is affirmative, the system allows the communication connection and protects the related data flow in the communication (step 406).

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A network audio/video communication system, used to ensure data security of an audio/video communication conducted through a network by verifying the user ID codes of a sending party and a receiving party and locking-in of the communication between the two parties, comprising:
a user ID code verification module, used to verify the ID code of the user to ensure that only the registered user may enter into the system;
a comparison module, used to compare the user ID code with the registered user ID code stored previously;
an authorization module, used to enable the sending party to define the authorization of the receiving party;
a lock-in module, used to lock-in the communication between the sending party and receiving party; and
a network connection module, used to activate or close the network connection, connect user equipment, and enable data sharing between the sending party and the receiving party.

2. The network audio/video communication system as claimed in claim 1, further comprising
a press key control module, used to provide at least one authorization selection to the sending party;
a data base module, used to store the registered user ID code stored previously;
a receiving party signal detection module, used to receive the signal indicating the connection of the system and the receiving party; and
a display interface module, used to display at least one alarm signal through a display device.

3. The network audio/video communication system as claimed in claim 1, wherein said locking-in module is a MAC address processing module, which is used to lock-in the communication between the sending party and receiving party through detecting the MAC addresses of the sending party and the receiving party, and locking-in said MAC addresses.

4. A network audio/video communication method, used to ensure data security of an audio/video communication conducted through a network by verifying the user ID codes of a sending party and a receiving party and locking-in the communication between the two parties, comprising the following steps:
activating the audio/video communication session;
verifying the user ID codes of the sending party and the receiving party;
determining the authorization level of the receiving party by the sending party based on the user ID code of the receiving party;
locking-in the communication connection between the sending party and the receiving party; and
activating the communication connection between the sending party and the receiving party.

5. The network audio/video communication method as claimed in claim 4, wherein
the step of activating an audio/video communication session further comprising the following steps:
issuing a activation signal to the network system for activating the audio/video communication session;
processing the activation signal by the network system;
determining the verification status of the user ID code of the sending party;
waiting for the connection of the receiving party if the user ID code of the sending party is valid; and
determining the verification status of the user ID code of the receiving party when detecting the connection of receiving party by the communication system, until the matching receiving party is found.

6. The network audio/video communication method as claimed in claim 4, wherein
the step of verifying the user ID codes of the sending party and the receiving party further comprising the following steps:
comparing the user ID code with the data in a data base module, determining the registration status of the user ID code;
generating an alarm signal reminding the user to register if the user ID code is not registered, disallowing the user entering into the communication session, and automatically refusing the any requests from the user; and
allowing the user to enter the communication session if the user ID is registered.

7. The network audio/video communication method as claimed in claim 4, wherein
the step of verifying the sending party to authorize the receiving party further comprising the following steps:
generating a question signal to the sending party to determine the authorization level of the receiving party;
if the authorization level of the receiving party is read only status, then the receiving party may only read the data provided by the sending party;
if the authorization level of the receiving party is write only status, then the receiving party may only edit the data provided by the sending party;
if the authorization level of the receiving party is read and write status, then the receiving party may read and edit the data provided by the sending party;
storing the selected status;
continuing the selected status until receiving a signal from the sending party indicating changing the authorization status of the receiving party;
if a data processing is underway between the sending party and the receiving party, then disallowing the change of the, authorization status of the receiving party; and
if the data processing is not underway, then changing the authorization status of the receiving party according to the requested by the sending party.

8. The network audio/video communication method as claimed in claim 4, wherein
the step of locking-in the communication connection between the sending party and the receiving party further comprising the following steps:
detecting the MAC addresses of the sending party and the receiving party;
storing automatically the obtained MAC addresses by the system;
issuing a lock-in signal to lock-in the MAC addresses; and
connecting the communication and protecting the data flow of the communication if the lock-in is successful.
